(19) United States
(12) Patent Application Publication
(10) Pub. No.: US 2005/0041858 A1
(43) Pub. Date: Feb. 24, 2005

(54) Apparatus and method for distributing portions of large web pages to fit smaller constrained viewing areas

(75) Inventors: Joseph Celi JR., Boca Raton, FL (US); Sivakumar Rajendran, Durham, NC (US); Michael Joseph Sullivan, Cedar Park, TX (US); Jonathan Mark Wagner, Round Rock, TX (US)

Correspondence Address: Rudolf O. Siegesmund;Suite 2000, 4627 N. Central Expressway, Dallas, TX, 75205-4017, US

(73) Assignee: International Business Machines Corporation, Armonk, NY (US)

(21) Appl. No.: 10/645,180

(22) Filed: Aug. 21, 2003

(51) Int. Cl. G06K 9/34

(52) U.S. Cl. 382/173

(57) ABSTRACT

The present invention is a methodology for displaying a web page on a hand held display device (HHDD). The invention comprises a Web Page Modification Program (WPMP) and a Navigation Program (NP). The WPMP creates a bitmap image of the web page. The WPMP records the location of the web page hyperlinks and creates an illusion of a working hyperlink by creating a segmented image on the image map where the hyperlink would be. The WPMP then displays a fragment of the image on the HHDD at the resolution intended by the web page designer. Thus the present invention allows the user to view a fragment of the web page at the intended resolution without having to load the entire web page onto the HHDD. The NP of the present invention allows the user to move from one fragment to another. An alternative embodiment utilizing a proxy is also disclosed.

### FIELD OF THE INVENTION

The present invention is directed generally towards an apparatus and method for displaying web pages on hand held display devices and specifically towards an apparatus and method for displaying a fragment of web page at the web page's intended resolution.

### BACKGROUND OF THE INVENTION

Web pages existing on the Internet are well known in the art. Users view web pages using a web browser such as Microsoft's Internet Explorer® or Netscape's Navigator®. The architects of web pages are generally referred to as web page designers. The web page designers layout web page elements, such as images, text, and hyperlinks, in an orderly fashion so that the user may quickly obtain useful information from the web page. The size of a web page is generally referred to as the web page resolution. Web page designers layout the web page and set the web page resolution for display on desktop or notebook computer screens.

Wireless telephones and personal digital assistants (PDAs) with web browsing capabilities are also well known in the art. These devices are generally known as hand held display devices (HHDDs). FIG. 1 is an example of a web page 20 commonly viewed on a HHDD. The web browser controls are not shown in FIG. 1; only the display screen rendering produced by the web page hyper text markup language (HTML) is shown. Web page 20 comprises image 22, hyperlinks 24, and text 26. Other web pages may have additional features such as menus, radio buttons, checkboxes, or animation. One of the problems encountered with browsing the Internet with a HHDD web browser is that the display screen on a HHDD is much smaller than the display screen on a desktop or notebook computer. In order to display a web page on the smaller screen, the HHDDs generally shrink or reduce the web page down to a smaller resolution. Thus, the user sees a smaller version of the web page. However, reducing the size of the web page is problematic because the web page elements, such as images 22, hyperlink 24, and text 26, may become too small to read or understand. This is particularly problematic when the user is attempting to discern information from the text, hyperlinks, or images within the web page, such as image 22, hyperlink 24, or text 26. Therefore, a need exists in the art for a method of displaying web page elements at their intended resolution on an HHDD display screen.

The prior art has previously addressed the problem of viewing reduced web pages. For example, U.S. Pat. No. 6,300,947 (the '947 patent) entitled “Display Screen and Window Size Related Web Page Adaptation System” discloses a method of adapting web pages to fit onto smaller screens. The method of the '947 patent involves breaking elements of the web page apart and separately displaying the elements on different screens. However, the method in the '947 patent is not preferable because the user is not able to view a web page at the intended resolution.

U.S. patent application Publication 2002/0158908 (the '908 application) entitled “Web Browser User Interface for Low-Resolution Displays” also discloses a method of adapting web pages to fit onto smaller screens. The method of the '908 application displays a portion of the web page on the HHDD display screen at the web page's intended resolution. The screen resolution produced by the method of the '908 application is preferable because the web page is displayed at the intended resolution. However, the method disclosed in the '908 application of producing the screen resolution is not preferable because the process of loading the entire web page onto the HHDD is time consuming. In extreme cases, the time required to load the entire web page may be prohibitive. Moreover, the web page hyperlinks may be inoperable when they are cut off by the HHDD display screen. Therefore, a need exists for an improved method of viewing a web page at the web page's intended resolution and utilizing hyperlinks on a HHDD.

Consequently, a need exists in the art for an improved apparatus and method of viewing a web page on a HHDD. The need extends to an apparatus and method for decreasing the time required to load a web page on a HHDD, which allows the user to view the web page at the web page's intended resolution. Moreover, the need extends to a method which allows the user to navigate the web page such that the user may view the entire web page at the web page's intended resolution, albeit in separate, distinct sections. Finally, the need extends to a method of viewing a web page on a HHDD that allows the user to operate the hyperlinks on the web page displayed on the HHDD.

### SUMMARY OF THE INVENTION

The present invention, which meets the needs stated above, is a methodology for displaying a web page on a hand held display device (HHDD), such as a wireless telephone or personal digital assistant (PDA). The software embodiment of the present invention comprises a Web Page Modification Program (WPMP) and a Navigation Program (NP). The WPMP analyzes the web page HTML to determine if the web page is larger than the display screen on the HHDD. If the web page is larger than the HHDD display screen, then the WPMP creates a bitmap image of the web page. As the WPMP is creating the web page image file, the WPMP records the location of the hyperlinks on the web page and creates an illusion of a working hyperlink on the web page image by creating a segmented image on the image map where the hyperlink would be. The WPMP calculates the required number of x-axis and y-axis divisions and fragments the image accordingly. The WPMP then displays a fragment of the image on the HHDD. The fragment is displayed at the resolution intended by the web page designer. Thus the present invention allows the user to view an image of the web page at the intended resolution without having to load the entire web page onto the HHDD. The NP of the present invention allows the user to move from one fragment to another.

Alternatively, the software embodiment of the present invention may comprise a Proxy Modification Program (PMP) and a Proxy Navigation Program (PNP). The PMP and PNP work similarly to the WPMP and NP, but utilize a proxy to decrease the amount of information that must be transmitted to the HHDD. Specifically, the PMP converts the web page into a bitmap image, creates the image segments, fragments the image, and only sends a single fragment of the web page image to the HHDD. If desired, the user may request other fragments using the PNP.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an example of a prior art web page downloadable over the Internet;

FIG. 2 is an illustration of a computer network used to implement the present invention;

FIG. 3 is an illustration of a communications system used to implement the present invention,

FIG. 4 is an illustration of a hand-held display device (HHDD) used to implement the present invention;

FIG. 5 is an illustration of the memory and processor used to implement the present invention;

FIG. 6 is an illustration of the logic of the Web Page Modification Program (WPMP) of the present invention;

FIG. 7 is an illustration of the logic of the Navigation Program (NP) of the present invention;

FIG. 8 is an illustration of the logic of the Proxy Modification Program (PMP) of the present invention;

FIG. 9 is an illustration of the logic of the Proxy Navigation Program (PNP) of the present invention;

FIG. 10 is an example of a web page containing a fragmented image produced by the present invention;

FIG. 11 is an example of the web page produced by the present invention; and

FIG. 12 is an example of a HHDD with a web browser displaying a web page produced by the present invention.

### DETAILED DESCRIPTION OF THE PREFERRED EMBODIMENT

As used herein the term “computer” shall mean a machine having a processor, a memory, and an operating system, capable of interaction with a user or other computer, and shall include without limitation desktop computers, notebook computers, personal digital assistants (PDAs), servers; handheld computers, and similar devices.

As used herein, the term “display screen” means a device used to display a graphical user interface of a computer program. Examples of display screens are liquid crystal display (LCD) screens, plasma screen, cathode ray tubes, computer monitors, thin film transistor (TFT) screens, and the like. Persons of ordinary skill in the art are aware of other types of display screens.

As used herein, the term “HHDD” is an acronym for “hand held display device” and means any portable device capable of displaying an image. Examples of HHDDs are wireless telephones, personal digital assistants (PDAs), handheld computers, digital cameras, and similar devices.

As used herein, the term “image” means any graphical depiction of an object, scene, or data. Images are typically stored in computer files ending with a .jpg, .bmp, or .gif file name suffix. Persons of ordinary skill in the art are aware of other types of image files.

As used herein, the term “image map” means a map to the elements found on a particular web page. Older Web browsers support only server-side image maps, which are executed on a Web server through CGI script. However, the newer Web browsers (Netscape Navigator 2.0 and higher and Internet Explorer 3.0 and higher) support client-side image maps, which are executed in a user's Web browser.

As used herein, the term “intended resolution” means the resolution of an image or screen of a web page that was intended by the web page designer.

As used herein, the term “proxy” means a computer operating between a HHDD and a computer containing the HTML of a desired web page, which is able to modify HTML code. When a user accesses a web site through a proxy, the proxy communicates with the computer containing the HTML and the proxy serves the HTML script directly to the HHDD, eliminating the need for the HHDD to communicate with the computer containing the HTML. In the proxy embodiment of the present invention, the proxy modifies the HTML code to fragment certain images.

As used herein, the term “resolution” means the size of an image or screen measured in pixels in both the x-axis and the y-axis.

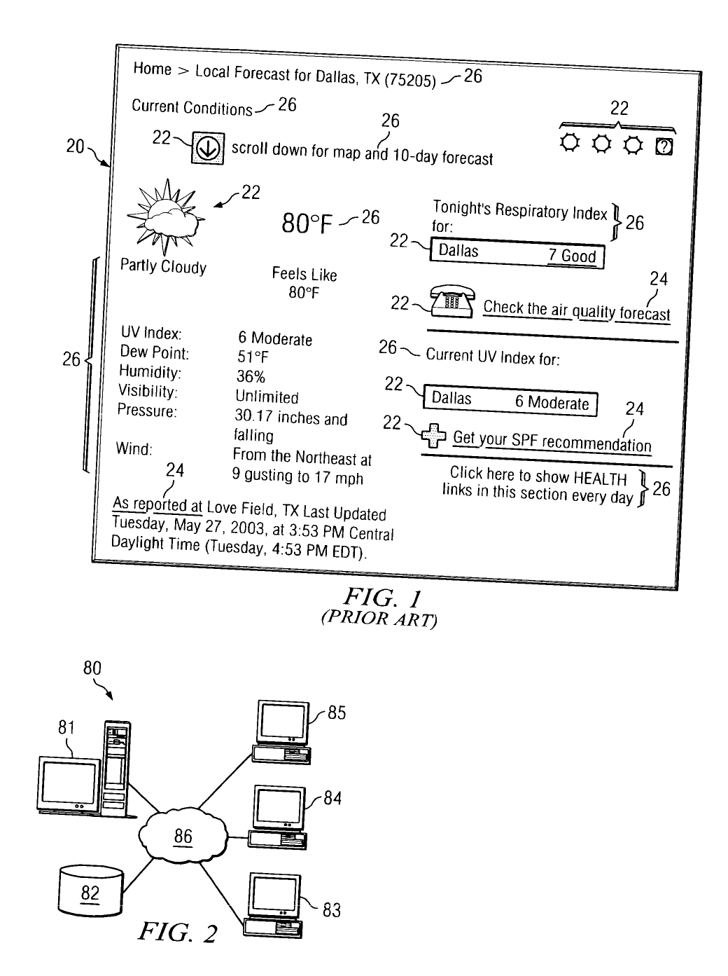

FIG. 2 is an illustration of computer network 80 associated with the present invention. Computer network 80 comprises local machine 85 electrically coupled to network 86. Local machine 85 is electrically coupled to remote machine 84 and remote machine 83 via network 86. Local machine 85 is also electrically coupled to server 81 and database 82 via network 86. Network 86 may be a simplified network connection such as a local area network (LAN) or may be a larger network such as a wide area network (WAN) or the Internet. Furthermore, computer network 80 depicted in FIG. 2 is intended as a representation of a possible operating network that may contain the present invention and is not meant as an architectural limitation.

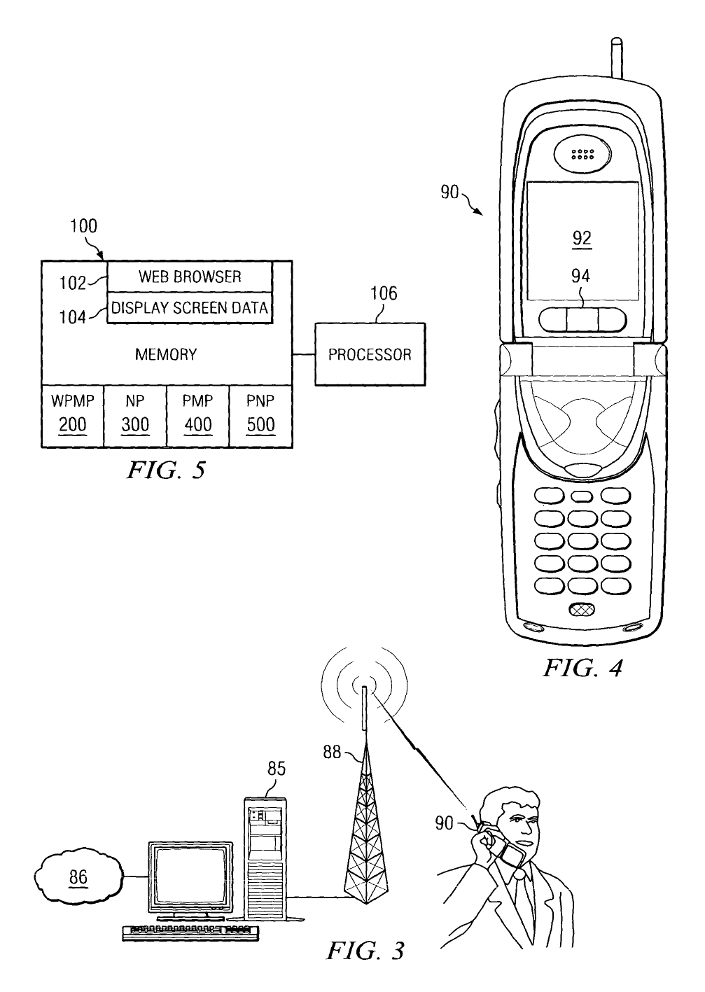

FIG. 3 is an illustration of a communications network used to implement the present invention. Local machine 85, connected to network 86 may also be connected to transmitter/receiver 88. Transmitter/receiver 88 is capable of wireless communication with a plurality of devices, including hand held display device (HHDD) 90. HHDD 90 is capable of two-way communication with computer network 80, which may be the Internet, through transmitter/receiver 88 and local machine 85.

FIG. 4 is an illustration of HHDD 90. HHDD 90 comprises display screen 92 and navigation buttons 94. When HHDD 90 is used to access the Internet, the user may view web pages on display screen 92 and enter data through a plurality of navigation buttons 94.

The internal configuration of a computer, including connection and orientation of the processor, memory, and input/output devices, is well known in the art. The present invention is a methodology that can be embodied in a computer program. Referring to FIG. 5, the methodology of the present invention is implemented on software by Web Page Modification Program (WPMP) 200. WPMP 200 includes Navigation Program (NP) 300, Proxy Modification Program (PMP) 400, and Proxy Navigation Program (PNP) 500. WPMP 200, NP 300, PMP 400, and PNP 500 described herein can be stored within the memory of any computer depicted in FIG. 2 or HHDD 90 depicted in FIGS. 3 and 4. Alternatively, WPMP 200, NP 300, PMP 400, and PNP 500 can be stored in an external storage device such as a removable disk, a CD-ROM, or a USB storage device. Memory 100 is illustrative of the memory within one of the computers of FIGS. 2, 3 or 4. Memory 100 also contains web browser 102 and display screen data 104. The present invention may interface with web browser 102 and/or display screen data 104 through memory 100. As part of the present invention, the memory 100 can be configured with WPMP 200, NP 300, PMP 400, and/or PNP 500. Processor 106 can execute the instructions contained in WPMP 200, NP 300, PMP 400, and/or PNP 500.

In alternative embodiments, WPMP 200, NP 300, PMP 400, and/or PNP 500 can be stored in the memory of other computers. Storing WPMP 200, NP 300, PMP 400, and/or PNP 500 in the memory of other computers allows the processor workload to be distributed across a plurality of processors instead of a single processor. Further configurations of WPMP 200, NP 300, PMP 400, and/or PNP 500 across various memories are known by persons of ordinary skill in the art.

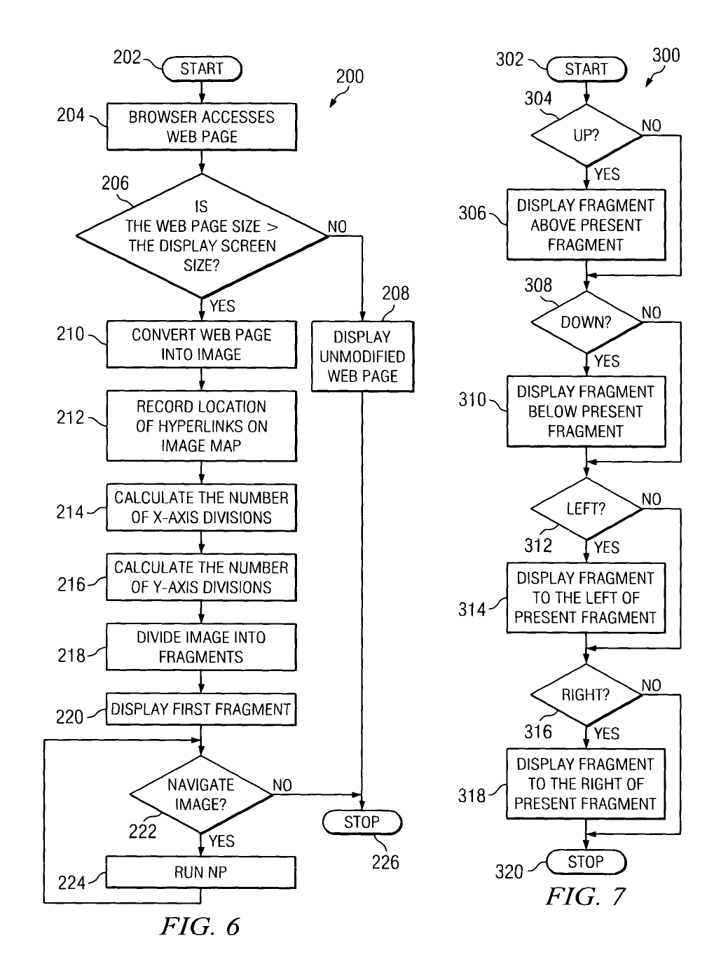

Turning to FIG. 6, the logic of Web Page Modification Program (WPMP) 200 is illustrated. WPMP 200 is a program that creates a bitmap image of the desired web page, fragments the web page image, and displays a portion of the web page image at the web page's intended resolution. WPMP 200 starts (202) whenever the user opens a web browser application. Web browsers are well known in the art and examples of web browsers include Microsoft's Internet Explorer® and Netscape's Navigator®. When using a web browser, the user enters a desired web page uniform resource locator (URL) and WPMP 200 follows the web browser to the desired web page (204). WPMP 200 then analyzes the web page's hyper text markup language (HTML) and determines if the web page is larger than the HHDD display screen (206). WPMP 200 can determine the size of the display screen from the display screen data 104 illustrated in FIG. 5. The web page size can be obtained from the web page HTML. In comparing the web page size to the display screen size, WPMP 200 will determine that the image is larger than the display screen if either: the x-axis dimension of the web page is larger than the x-axis dimension of the HHDD display screen, or the y-axis dimension of the image is larger than the y-axis dimension of the HHDD display screen. The web page size will almost always be larger than the HHDD display screen. If the web page is not larger than the HHDD display screen size, then WPMP 200 displays the unmodified web page (208) and ends (226). If the web page is larger than the HHDD display screen, then WPMP proceeds to step 210.

At step 210, WPMP 200 analyzes the web page HTML code and creates a bitmap image similar to the display screen rendering produced by the web page's HTML (210). The image created can also be a .jpg or .gif file. Persons of ordinary skill in the art are aware of other type of image files. As WPMP 200 analyzes the HTML code, WPMP 200 notes the location of the hyperlinks in the code. WPMP 200 records the location of these hyperlinks on the image map for the web page image (212). In other words, WPMP 200 creates a series of segmented images in the same location that the hyperlink would be on the web page. If the user clicks on an image segment, the image map instructs the browser to go to the web page or location indicated by the hyperlink. The image segment can also be mouse sensitive so that when the cursor is moved over the image segment, the user is directed to the new web page or location. The advantage of using segmented images over hyperlinks becomes apparent when the web page image is fragmented in step 218. If the web page was fragmented without the use of segmented images, then the hyperlinks would only direct the user to the linked web page so long as the entire hyperlink was viewable on the image fragment. If a hyperlink is fragmented into two pieces, each piece of the hyperlink directs the user to a URL represented by that specific piece of the hyperlink. For example if the hyperlink www.weather.com is fragmented into www.we and ather.com then the user would be directed to the web pages www.we and ather.com respectively, not the desired web page of www.weather.com. If the web pages www.we and ather.com do not exist, the user will receive an error message. In contrast, the present invention creates an image segment that will direct the user to the web page www.weather.com whenever the user clicks on any pixel within the defined image segment, regardless of the fragmentation of the image segment. Thus, the user is able to go to the same location or web page as if he were using a hyperlink. The use of image segments is not visible on the fragmented image and, therefore, not apparent to the user.

WPMP 200 then calculates the number of x-axis divisions (214). The number of x-axis divisions is equal to the web page x-axis dimension divided by the HHDD display screen x-axis dimension, rounded up to the nearest whole number. Rounding up ensures that the entire web page will be displayed at the intended resolution. For example, if a web page has an x-axis dimension of 600 pixels and the HHDD display screen x-axis dimension is 200 pixels, then there are three x-axis divisions

$$( \frac{600 pixels}{200 pixels} = 3 divisions ) .$$

If the quotient obtained in calculating the x-axis divisions contains a remainder, then the last x-axis division will contain part of the original web page displayed at the intended resolution.

WPMP 200 then calculates the number of y-axis divisions (216). The number of y-axis divisions is equal to the web page y-axis dimension divided by the HHDD display screen y-axis dimension, rounded up to the nearest whole number. Rounding up ensures that the entire web page will be displayed at the intended resolution. For example, if a web page has a y-axis dimension of 405 pixels and the HHDD display screen y-axis dimension is 135 pixels, then there are three y-axis divisions

$$( \frac{405 pixels}{135 pixels} = 3 divisions ) .$$

If the quotient obtained in calculating the 135 pixels y-axis divisions contains a remainder, then the last y-axis division will contain part of the original web page displayed at the intended resolution.

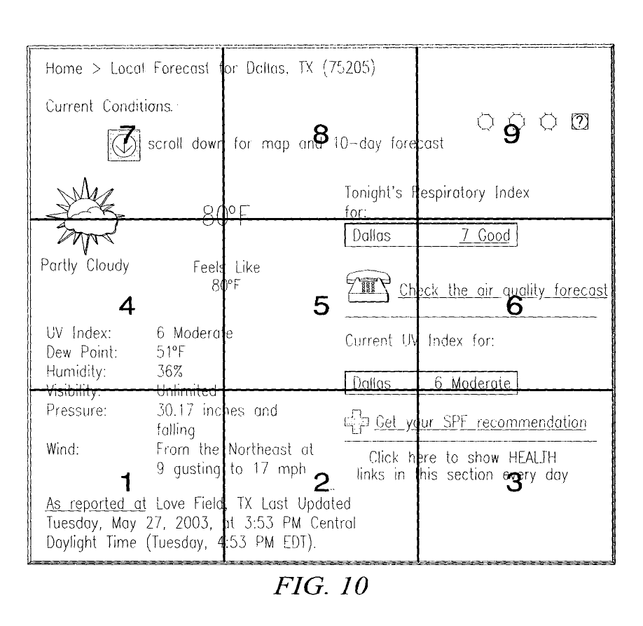

Next, WPMP 200 divides the web page image into fragments (218). The number of fragments is equal to the number of x-axis divisions multiplied by the number of y-axis divisions. When fragmenting the web page image, WPMP 200 repeatedly breaks-up the web page image into fragments along the x-axis at the configured screen x-axis dimension. For example, if the web page image is 600 pixels wide along the x-axis and the HHDD display screen x-axis dimension is 200 pixels, then WPMP 200 will break up the web page image at the 200^{th} pixel and the 400^{th} pixel, producing a total of three fragments along the x-axis. Similarly, WPMP 200 repeatedly breaks-up the web page image into fragments along the y-axis at the HHDD display screen y-axis dimension. For example, if the web page image is 405 pixels wide along the y-axis and the configured screen y-axis dimension is 135 pixels, then WPMP 200 will break up the web page image at the 135^{th} pixel and the 270^{th} pixel, producing a total of three fragments along the y-axis. Thus, the total web page image is broken into nine distinct fragments. An example of a fragmented web page image can be seen in FIG. 10. WPMP 200 stores the fragmented web page image in cache memory under a distinct file name.

WPMP 200 then displays the first web page image fragment (220). In displaying the web page image fragment, the user views only a portion of the total web page at the web page's intended resolution. However, the present invention differs from the prior art in that the method used to produce the final image requires far less processing by the HHDD than the prior art methods of viewing a web page at the web page's intended resolution. When displaying the web page image fragment, WPMP 200 can first display the center fragment or any other fragment that has been created by WPMP 200.

WPMP 200 then determines if the user wants to navigate the fragmented web page image (222). If the user wants to navigate the fragmented web page image, then WPMP 200 runs NP 300 (224) and returns to step 222. If the user does not want to navigate the fragmented web page image, WPMP 200 ends (226).

Turning to FIG. 7, the logic of Navigation Program (NP) 300 is illustrated. NP 300 is a program that navigates the web page image fragmented by WPMP 200. NP 300 starts (302) when prompted by WPMP 200. NP 300 then makes a determination whether the user has pressed an up button (304). If the user has pressed the up button, NP 300 displays the fragment directly above the present fragment (306) and proceeds to step 308. If the user has not pressed the up button, then NP 300 proceeds to step 308 where NP 300 makes a determination whether the user has pressed the down button (308). If the user has pressed the down button, NP 300 displays the fragment directly below the present fragment (310) and proceeds to step 312. If the user has not pressed the down button, then NP 300 proceeds to step 312 where NP 300 makes a determination whether the user has pressed the left button (312). If the user has pressed the left button, NP 300 displays the fragment directly to the left of the present fragment (314) and proceeds to step 316. If the user has not pressed the left button, then NP 300 proceeds to step 316 where NP 300 makes a determination whether the user has pressed the right button (316). If the user has pressed the right button, NP 300 displays the fragment directly to the right of the present fragment (318) and ends (320). If the user has not pressed the right button, then NP 300 ends (320).

Persons of ordinary skill in the art are aware of other methods of indicating a desire to navigate a fragmented image other than pressing buttons. Persons of ordinary skill in the art will also appreciate that a fragmented image may be wrapped top-to-bottom such that a user can reach the top row of a fragmented image by pressing down from the bottom row and vice-versa. Similarly, persons of ordinary skill in the art will also appreciate that a fragmented image may be wrapped left-to-right such that a user can reach the left row of a fragmented image by pressing right from the right row and vice-versa.

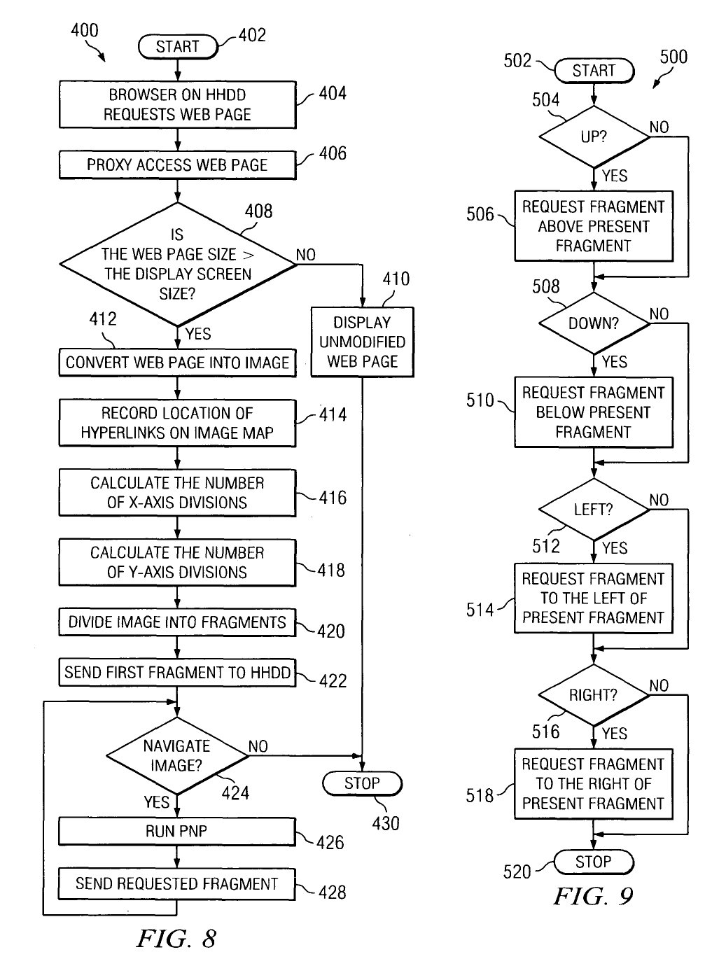

Turning to FIG. 8, the logic of Proxy Modification Program (PMP) 400 is illustrated. PMP 400 is a program that creates an image of the desired web page, fragments the web page image, and displays a portion of the web page image at the web page's intended resolution similar to WPMP 200, but with the use of a proxy. PMP 400 operates on a proxy and automatically converts the web page into a bitmap image, creates the image segments, and fragments the image for the HHDD. PMP 400 starts (402) whenever the user opens a web browser application. When using a web browser, the user enters a desired web page uniform resource locator (URL) (404) and PMP 400 instructs the proxy to access the desired web page (406). PMP 400 then analyzes the web page's HTML and determines if the web page is larger than the HHDD display screen (408). PMP 400 can determine the size of the display screen from the display screen data 104 illustrated in FIG. 5. The web page size can be obtained from the web page HTML. If the web page is not larger than the HHDD display screen size, then PMP 400 displays the unmodified web page (410) and ends (430). If the web page is larger than the HHDD display screen, then PMP proceeds to step 412.

At step 412, PMP 400 analyzes the web page HTML code and creates a bitmap image similar to the display screen rendering provided by the web page's HTML (412). The image created can also be a .jpg or .gif file. Persons of ordinary skill in the art are aware of other type of image files. As PMP 400 analyzes the HTML code, PMP 400 notes the location of the hyperlinks in the code. PMP 400 records the location of these hyperlinks on the image map for the web page image (414). PMP 400 then calculates the number of x-axis divisions (416). The number of x-axis divisions is equal to the web page x-axis dimension divided by the HHDD display screen x-axis dimension, rounded up to the nearest whole number. PMP 400 then calculates the number of y-axis divisions (418). The number of y-axis divisions is equal to the web page y-axis dimension divided by the HHDD display screen y-axis dimension, rounded up to the nearest whole number.

Next, PMP 400 divides the web page image into fragments (420). The number of fragments is equal to the number of x-axis divisions multiplied by the number of y-axis divisions. An example of a fragmented web page image can be seen in FIG. 10. PMP 400 stores the fragmented web page image in cache memory under a distinct file name called the unique identifier. The proxy creates a unique identifier for the fragmented web page image so that the proxy is able to identify a particular user with a particular fragmented web page image. An example of a unique identifier is the exact time, to the nanosecond, that the user requests a web page.

PMP 400 then sends the first web page image fragment to the HHDD for display on the HHDD display screen (422). In displaying the web page image fragment, the user views only a portion of the total web page at the web page's intended resolution. However, the present invention differs from the prior art in that the method used to produce the final image requires far less processing by the HHDD than the prior art methods of viewing a web page at the web page's intended resolution. When displaying the web page image fragment, PMP 400 can first display the center fragment or any other fragment as determined by persons of ordinary skill in the art.

PMP 400 then determines if the user wants to navigate the fragmented web page image (424). If the user wants to navigate the fragmented web page image, then PMP 400 runs PMP 500 (426), sends the requested fragment to the HHDD (428), and returns to step 424. If the user does not want to navigate the fragmented web page image, PMP 400 ends (430).

Turning to FIG. 9, the logic of Proxy Navigation Program (PNP) 500 is illustrated. PNP 500 is a program that navigates the image fragmented by PMP 400. Generally, PNP 500 notifies the proxy of the currently displayed image fragment and the desired image fragment. The proxy then sends the requested image fragment to the HHDD. PNP 500 starts (502) when prompted by PMP 400. PNP 500 then makes a determination whether the user has pressed an up button (504). If the user has pressed the up button, PNP 500 requests the fragment directly above the present fragment (506) and proceeds to step 508. If the user has not pressed the up button, then PNP 500 proceeds to step 508 where PNP 500 makes a determination whether the user has pressed the down button (508). If the user has pressed the down button, PNP 500 requests the fragment directly below the present fragment (510) and proceeds to step 512. If the user has not pressed the down button, then PNP 500 proceeds to step 512 where PNP 500 makes a determination whether the user has pressed the left button (512). If the user has pressed the left button, PNP 500 requests the fragment directly to the left of the present fragment (514) and proceeds to step 516. If the user has not pressed the left button, then PNP 500 proceeds to step 516 where PNP 500 makes a determination whether the user has pressed the right button (516). If the user has pressed the right button, PNP 500 requests the fragment directly to the right of the present fragment (518) and ends (520). If the user has not pressed the right button, then PNP 500 ends (520).

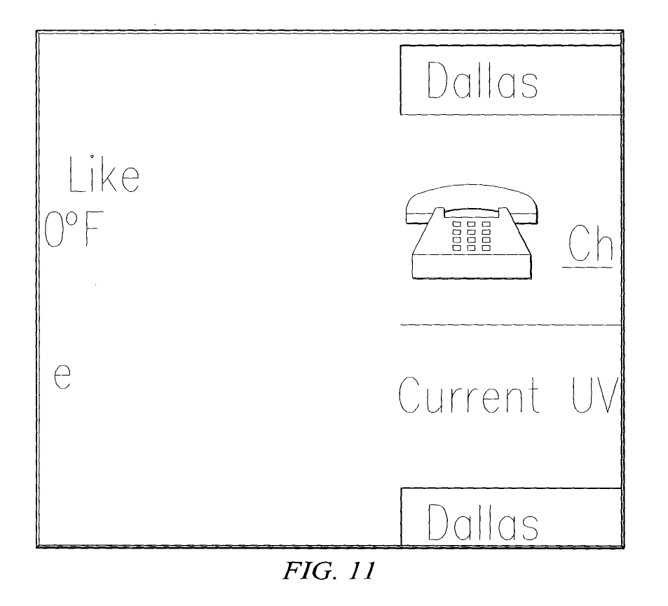

Returning to FIG. 1, a web page containing text, hyperlinks, and images is illustrated. The illustrated web page is characteristic of the type of web page that a HHDD user would want to access because the text, hyperlinks, and images are equally informative. The web page contains a large amount of information displayed in great detail. When web page 20, such as the illustration in FIG. 1, is reduced to fit onto the smaller screen of a HHDD, much of the information on the web page will be too small to be of any use to the user. Therefore, the present invention creates an image of the web page and fragments the web page image using WPMP 200 or PMP 400, as illustrated in FIG. 10. Note that the present invention fragments the entire image of the web page including any images, text, and/or hyperlinks. One of the numbered fragments may then be displayed on the HHDD such that the user can view a portion of the image of the original web page, and is able to discern all of the information that is readily discernable from the web page because the web page image fragment is displayed at the intended resolution. FIG. 11 is an illustration of a HHDD running a web browser utilizing the present invention. As can be seen in FIG. 11, the web browser displays the fifth (center) web page image fragment so that the user may view the web page at the intended resolution.

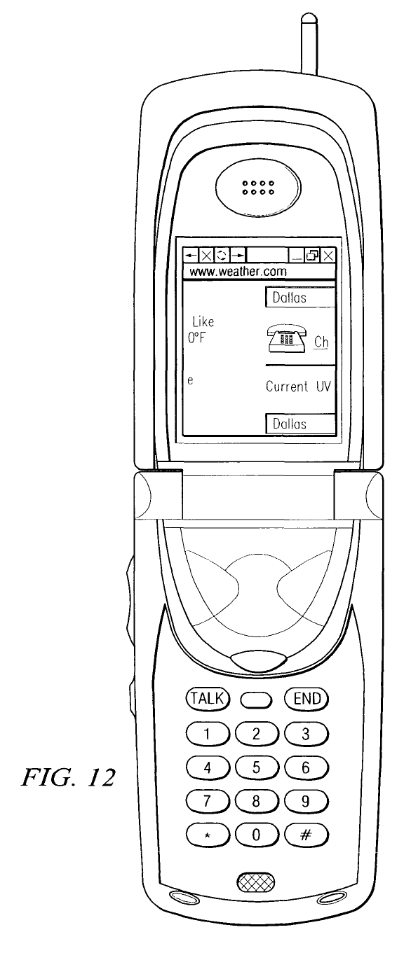

Turning to FIG. 11, the web page of the present invention is illustrated. The web page in FIG. 11 is identical to piece five from the web page in FIG. 1. The hyperlink “Ch” on the left side of the web page image has been converted into an image segment. As can be seen in FIG. 11, the user is unaware of the boundary between the image segment for “Ch” and the remainder of the web page image. When a HHDD displays the web page of FIG. 11, the web page image fragment is at the resolution intended by the web page designer. FIG. 12 is an illustration of a HHDD running a web browser utilizing the present invention. The web page displayed on the web browser of the HHDD in FIG. 12 is identical to the web page in FIG. 11. As can be seen in FIG. 12, the web browser displays the fifth (center) web page image fragment so that the user may view the web page image at the intended resolution.

While the preferred embodiment of the present invention is directed at browsing the Internet using a HHDD, the preferred embodiment is not meant as a limitation of the present invention. For example, certain aspects of the present invention may be applicable to digital camera displays, particularly in higher resolution digital cameras. The liquid crystal display (LCD) screen of a digital camera can use the present invention to show the full size digital picture at the same resolution the digital picture will be printed. The present invention may also be applicable to full size display screen as well. Other applications of the novel and non-obvious aspects presented herein will be appreciated by a person of ordinary skill in the art.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The novel spirit of the present invention is still embodied by reordering or deleting some of the steps contained in this disclosure. The spirit of the invention is not meant to be limited in any way except by proper construction of the following claims.

1. A method for displaying a web page on a display screen comprising:
creating a web page image;
dividing the web page image into a plurality of fragments; and
displaying one of the fragments on the display screen.

2. The method of claim 1 further comprising:
determining if the size of a web page is larger than a display screen; and
responsive to a determination that the web page is larger than the display screen, performing the creating step.

3. The method of claim 1 wherein the fragment is displayed at the web page's intended resolution.

4. The method of claim 1 further comprising: responsive to a determination that the web page is not larger than the display screen, displaying the unmodified web page.

5. The method of claim 1 further comprising:
recording a location of at least one hyperlink;
creating an image segment on an image map in the same location of the hyperlink; and
wherein the image segment directs the user to another web page or location.

6. The method of claim 1 further comprising: calculating the number of x-axis divisions.

7. The method of claim 1 further comprising: calculating the number of y-axis divisions.

8. The method of claim 1 further comprising:
determining if a user wants to navigate the web page image; and
responsive to a determination that a user wants to navigate the web page image, running a navigation program.

9. The method of claim 1 wherein the displaying step occurs on a hand held display device.

10. The method of claim 1 further comprising:
accessing the web page through a proxy; and
wherein the proxy sends only one fragment to a hand held display device.

11. The method of claim 10 further comprising:
requesting another fragment; and
wherein the proxy sends another fragment to the hand held display device.

12. The method of claim 10 wherein the web page image is identified by a unique identifier.

13. The method of claim 1 wherein the web page image is stored in an image file ending in .gif, .jpg, or .bmp.

14. A program product operable on a computer, the program product comprising:
a computer-usable medium;
wherein the computer usable medium comprises instructions comprising:
instructions for creating a web page image;
instructions for dividing the web page image into a plurality of fragments; and
instructions for displaying one of the fragments on the display screen.

15. The program product of claim 14 further comprising:
instructions for determining if the size of a web page is larger than a display screen; and
responsive to a determination that the web page is larger than the display screen, instructions for performing the creating step.

16. The program product of claim 14 wherein the fragment is displayed at the web page's intended resolution.

17. The program product of claim 14 further comprising: responsive to a determination that the web page is not larger than the display screen, instructions for displaying the unmodified web page.

18. The program product of claim 14 further comprising:
instructions for recording a location of at least one hyperlink;
instructions for creating an image segment on an image map in the same location of the hyperlink; and
wherein the image segment directs the user to another web page or location.

19. The program product of claim 14 further comprising: instructions for calculating the number of x-axis divisions.

20. The program product of claim 14 further comprising: instructions for calculating the number of y-axis divisions.

21. The program product of claim 14 further comprising:
instructions for determining if a user wants to navigate the web page image; and
responsive to a determination that a user wants to navigate the web page image, instructions for running a navigation program.

22. The program product of claim 14 wherein the instructions for displaying step occurs on a hand held display device.

23. The program product of claim 14 further comprising:
instructions for accessing the web page through a proxy; and
wherein the proxy sends only one fragment to a hand held display device.

24. The program product of claim 23 further comprising:
instructions for requesting another fragment; and
wherein the proxy sends another fragment to the hand held display device.

25. The program product of claim 23 wherein the web page image is identified by a unique identifier.

26. The program product of claim 14 wherein the web page image is stored in an image file ending in gif, .jpg, or .bmp.

27. A program product operable on a computer, the program product comprising:
a computer-usable medium;
wherein the computer usable medium comprises:
a web page modification program; and
a navigation program.

28. The program product of claim 27 wherein the web page modification program further comprises:
instructions for creating a web page image;
instructions for dividing the web page image into a plurality of fragments; and
instructions for displaying one of the fragments on the display screen.

29. The program product of claim 28 further comprising:
instructions for determining if the size of a web page is larger than a display screen; and
responsive to a determination that the web page is larger than the display screen, instructions for performing the creating step.

30. The program product of claim 28 wherein the fragment is displayed at the web page's intended resolution.

31. The program product of claim 28 further comprising: responsive to a determination that the web page is not larger than the display screen, instructions for displaying the unmodified web page.

32. The program product of claim 28 further comprising:
instructions for recording a location of at least one hyperlink;
instructions for creating an image segment on an image map in the same location of the hyperlink; and
wherein the image segment directs the user to another web page or location.

33. The program product of claim 28 further comprising: instructions for calculating the number of x-axis divisions.

34. The program product of claim 28 further comprising: instructions for calculating the number of y-axis divisions.

35. The program product of claim 28 further comprising:
instructions for determining if a user wants to navigate the web page image; and
responsive to a determination that a user wants to navigate the web page image, instructions for running a navigation program.

36. The program product of claim 28 wherein the instructions for displaying step occurs on a hand held display device.

37. The program product of claim 28 further comprising:
instructions for accessing the web page through a proxy; and
wherein the proxy sends only one fragment to a hand held display device.

38. The program product of claim 37 further comprising:
instructions for requesting another fragment; and
wherein the proxy sends another fragment to the hand held display device.

39. The program product of claim 37 wherein the web page image is identified by a unique identifier.

40. The program product of claim 28 wherein the web page image is stored in an image file ending in .gif, .jpg, or .bmp.
